(19) United States
(12) Patent Application Publication
(10) Pub. No.: US 2020/0233821 A1
(43) Pub. Date: Jul. 23, 2020

(54) UNIDIRECTIONAL INFORMATION CHANNEL TO MONITOR BIDIRECTIONAL INFORMATION CHANNEL DRIFT

(71) Applicant: Intel Corporation, Santa Clara, CA (US)

(72) Inventors: Arvind KUMAR, Brookline, MA (US); Dean-Dexter R. EUGENIO, Folsom, CA (US); John R. GOLES, Folsom, CA (US)

(21) Appl. No.: 16/827,205

(22) Filed: Mar. 23, 2020

(51) Int. Cl. G06F 13/20; G06F 13/16

(52) U.S. Cl. CPC G06F 13/20; G06F 13/1668

(57) ABSTRACT

An N-bit bus includes (N−1) bidirectional interfaces to couple to (N−1) bidirectional signal lines to exchange (transmit and receive) signals between companion devices. The bus includes two unidirectional signal line interfaces. The first is a unidirectional receive interface to couple to a unidirectional signal line to receive signals from the companion device. The second is a unidirectional transmit interface to couple to a unidirectional signal line to transmit signals to the companion device. The bus provides N signal lines for the N-bit bus in each direction, with an additional “backwards facing” signal line. The backwards facing signal line can allow the devices to prepare for a switch in the direction of the N-bit bus.

### FIELD

Descriptions are generally related to I/O (input/output), and more particular descriptions are related to adjusting I/O parameters of a bidirectional bus.

### BACKGROUND

A bidirectional bus allows two devices to exchange data over shared signal lines. A bidirectional bus can significantly reduce the signal line count connecting the two devices. A communication protocol typically controls how the devices take turns sending data over the shared signal lines. A common example of a bidirectional bus is in the memory device and controller scenario, where a bidirectional data bus allows the controller to send data as part of a write operation, and the memory device to send data as part of a read operation.

When the bidirectional bus is high-speed, for example, in a memory subsystem, the I/O (input/output) signal lines of the bus can have precisely tuned controls to enable the high speed communication. Without the control, the signals on the bus could be subject to significant noise, interference, and drift, resulting in high error rates. The control typically changes as environmental conditions (voltage drift, heat changes, or other conditions) to adapt the I/O driver and receiver circuits to the changing conditions.

If a receiver applies various controls to a received signal, it will be understood that a change in conditions could occur while data is flowing one direction on the bus. When the bus direction changes, the device that was transmitting becomes the receiver, and may not be tuned properly to receive high speed signaling. Thus, the device that has been transmitting may not have the proper I/O configuration settings to properly receive at the present state of the bus. As the speed of communication on the bus increases, the effects of drift can become a larger part of the eye margin, where the eye margin refers to the tolerance in signaling that will enable a receiver to properly decode a signal.

The bidirectional communication traditionally includes the ability to train the bus, which refers to finding I/O configuration settings that reduce the bit error rate for a given state of the bus. With a high speed bus, flipping the bus direction commonly results in the need to perform training to prepare the devices to communicate in the other direction. Such training can be referred to as handshaking. The need to engage in handshaking or I/O training increases communication delay as the devices set configuration instead of exchanging active data.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system having a reverse-facing data lane for I/O tracking.

FIG. 2 is a representation of an example of a data eye for a system having a reverse-facing data lane for I/O tracking.

FIG. 3 is a timing diagram of an example of communication over a data interface having a reverse-facing data lane for I/O tracking.

FIG. 4A is a block diagram of an example of a system having a reverse-facing data lane in a data interface with a master receive tracking circuit.

FIG. 4B is a block diagram of an example of a system having a reverse-facing data lane in a data interface with each receiver having a receive tracking circuit.

FIG. 5 is a block diagram of an example of a memory subsystem having a reverse-facing data lane for I/O tracking.

FIG. 6 is a block diagram of a I/O receiver with I/O tracking.

FIG. 7 is a block diagram of an example of a memory module with memory devices having a reverse-facing data lane for I/O tracking.

FIG. 8 is a flow diagram of an example of a process for bidirectional data transfer in a system with a reverse-facing data lane.

FIG. 9 is a block diagram of an example of a memory subsystem in which bidirectional data transfer with a reverse-facing data lane can be implemented.

FIG. 10 is a block diagram of an example of a computing system in which bidirectional data transfer with a reverse-facing data lane can be implemented.

FIG. 11 is a block diagram of an example of a mobile device in which bidirectional data transfer with a reverse-facing data lane can be implemented.

Descriptions of certain details and implementations follow, including non-limiting descriptions of the figures, which may depict some or all examples, and well as other potential implementations.

### DETAILED DESCRIPTION

A device includes an interface to an N-bit bidirectional bus. The N-bit bus includes (N−1) bidirectional interfaces to couple to (N−1) bidirectional signal lines to exchange (transmit and receive) signals between companion devices. In one example, the bidirectional bus is a single-ended bus. The bus includes two unidirectional signal line interfaces. The first is a unidirectional receive interface to couple to a unidirectional signal line to receive signals from the companion device. The second is a unidirectional transmit interface to couple to a unidirectional signal line to transmit signals to the companion device. A signal line can be referred to as a lane or as an information channel. Whether referred to as a signal line, lane, or information channel, the signal line enables the transmission of information signals to the companion device.

The bus provides N signal lines for the N-bit bus in each direction, with an additional “backwards facing” or “reverse facing” signal line. The additional unidirectional signal line faces backwards or in reverse because it is unidirectional in the opposite direction of the current flow of data on the bidirectional bus. The backwards facing signal line allows the companion devices to prepare for the bus to switch directions. The monitoring of the bus in the reverse direction can enable a device to prepare configuration settings for a present state of the bus. Thus, when the bus switches directions, the configuration settings for the device can be set for the present state of the bus, reducing or eliminating the training needed when the bus switches directions.

With one unidirectional lane each direction, the bus can provide N bits of information in each direction as traditionally done, with one lane that does not have to flip with the lanes in the bus. For example, consider a 10-bit bus, with 10 data signal lines. Instead of implementing the bus as traditionally done with 10 bidirectional lanes, the bus can be implemented with 11 signal lines: 9 bidirectional signal lines, one unidirectional signal line pointing one direction, and another unidirectional signal line pointing the other direction. Whichever direction the bus is pointing, there will be 10 signal lines to transmit data, and an additional signal line pointing the reverse direction.

The reverse direction refers to being in an opposite direction of the flow of data. Thus, the flow of direction is from transmitter to receiver, and the reverse direction is from receiver to transmitter. It will be understood that for a bidirectional bus, each of the companion devices will take turns as the transmitter and as the receiver. However, for any given transaction, one device will be the transmitter sending data and the other device will be the receiver receiving the data. The forward direction for data is from transmitter to receiver for the transaction, and the reverse direction is from receiver to transmitter for the same transaction. When the roles change, the bus direction changes.

As another example, consider a 4-bit bus, such as a x4 DQ bus, with 4 signal lines for each of M memory devices, for a total of M*4 DQ signal lines. Each of the M memory devices can have a 5-bit interface, with 3 bidirectional signal lines, one unidirectional signal line pointing from controller to memory device, and one unidirectional signal line pointing from memory device to controller. While an example of a x4 DQ bus is provided, it will be understood that the same techniques could be applied for a x8 DQ bus, a x16 DQ bus, or other bus width or width of a device data interface or device bus interface. Thus, it will be understood that the overhead cost of the additional unidirectional signal line can be reduced with wider interfaces.

The reverse-facing unidirectional signal line can send reverse metadata to the transmitter. In one example, the metadata is simply a dummy signal provided by the receiver. The dummy signal can be, for example, a known bit pattern (1010 . . . , 11001100 . . . , or some other pattern). With a known signal pattern, the transmitter can know what data to expect, and can track the conditions of communication over the bus.

In one example, instead of being a dummy signal, the metadata can be a data signal. The data signal can be any type of information specifically indicating conditions on the signal bus. In one example, the metadata signal can be one or more signals that would be used in a handshaking routine. Instead of needing to send data for a separate handshaking routine, the reverse-facing signal line can provide a reverse-direction handshake to be applied as soon as the bus changes direction.

In one example, the metadata signal includes information from the receiving signal to indicate settings for its I/O configuration. Thus, the devices can pass configuration information for one or more parameters to allow the other device to start at a configuration that should be close to accurate for the state of the bus.

Traditionally, when the bus flipped direction, the receiver had a very high likelihood of having the wrong configuration settings for the state of the bus. With the reverse direction monitoring, the devices can have the correct configuration settings as soon as the bus reverses direction, or can find the correct configuration settings very quickly after the bus switches directions.

The I/O configuration settings can refer to any one or more types of information used to configure a setting for an I/O transfer. Examples of I/O configuration settings can include, but are not limited to, speed, power, voltage, equalization, decision feedback equalization (DFE), phase, or other configuration settings. In general, the information that can be monitored is anything use for signaling. More specifically, the reverse direction signal line can be used for information for any I/O parameter that drifts or changes over time or with different conditions.

It will be understood that the reverse-facing data lane results in an additional signal line per bus in the system that applies what is described herein. The cost of the additional signal line(s) can be weighed against an expected reduction in time to compensate for the effects of the switch of direction of the bus. For example, in a memory subsystem, the use of additional signal line can be factored against the reduction in time to compensate for the effects of Read-to-Write or Write-to-Read strobe shift due to temperature and voltage. The strobe shift refers to a shift in phase of the DQS or data strobe signal.

A traditional approach to tracking phase drift of a DQS signal line is to use a DQS clock-tree oscillator. However, the use of a DQS clock-tree oscillator can require the memory controller to poll the memory device periodically to obtain delay values during runtime. It will be understood that such an operation requires the controller to issue extra commands to the memory, which consumes communication bandwidth between the controller and the memory device.

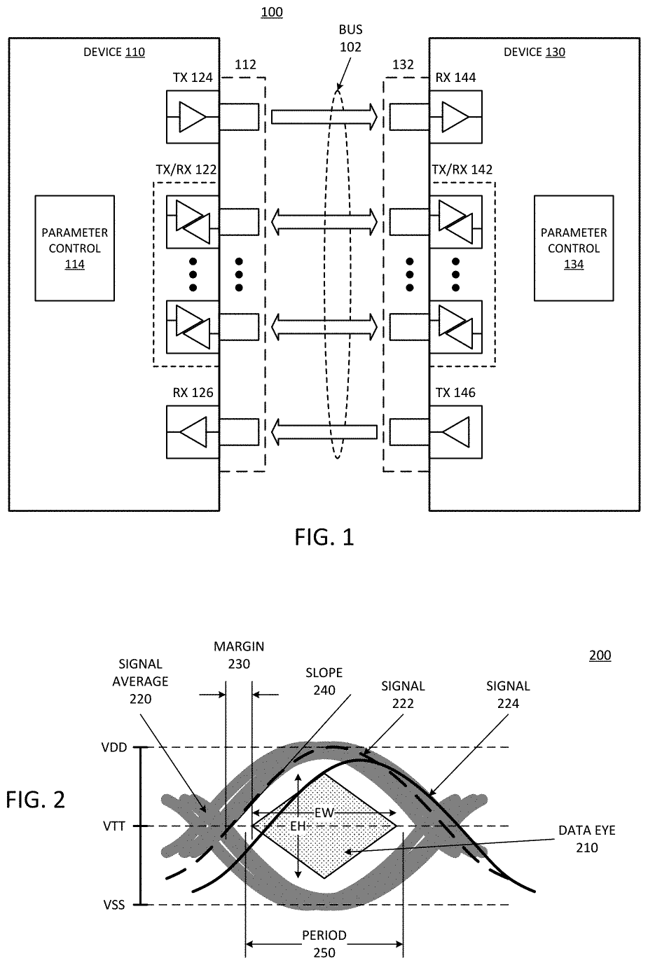

FIG. 1 is a block diagram of an example of a system having a reverse-facing data lane for I/O tracking. System 100 includes bus 102, which represents a bidirectional bus. In one example, bus 102 is a single-ended bus. A single ended bus refers to a bus where each signal line carries a different signal. An alternative to a single ended bus is a differential bus, which includes a signal line for a signal and a companion signal line for a complementary signal (the inverse or complement of the intended signal). Bus 102 can be any type of bidirectional bus.

Device 110 and device 130 will take turns being transmitter and receiver with respect to bus 102. Device 110 includes interface 112, which represents balls, pins, or other connectors to interface to the information channels of bus 102. Device 130 includes interface 132 with corresponding connectors to interface with bus 102.

Device 110 includes bidirectional interfaces represented as TX/RX 122. TX/RX 122 is represented as transceivers to provide communication in either direction. Device 130 includes TX/RX 142, which represent the corresponding bidirectional interfaces for device 130.

Device 110 includes two unidirectional interfaces. Device 130 also includes two unidirectional interfaces. TX (transmit) 124 represents an interface to a unidirectional information channel that flows from device 110 to device 130. TX 124 is a transmit-only interface for device 110. Device 130 includes RX (receive) 144, which corresponds to TX 124 of device 110. RX 144 is a receive-only interface for device 130, to receive signals sent by TX 124 on a unidirectional information channel of bus 102.

Similarly, TX 146 represents an interface to a unidirectional information channel that flows from device 130 to device 110. TX 146 is a transmit-only interface for device 130. Device 110 includes RX 126, which corresponds to TX 146 of device 130. RX 126 is a receive-only interface for device 110, to receive signals sent by TX 146 on a unidirectional information channel of bus 102. When an information channel is unidirectional in the reverse direction, in one example, it can be referred to as a tracking lane or tracking signal line.

Device 110 includes parameter control 114, which represents control for the configuration parameters for I/O for device 110. In one example, parameter control 114 represents the control to be implemented over I/O parameters in response to signals received via RX 126 when device 110 is transmitting on TX/RX 122 and TX 124. Signals on RX 126 when device 110 is transmitting to device 130 will be metadata signals.

Device 130 includes parameter control 134, which represents control for the configuration parameters for I/O for device 130. In one example, parameter control 134 represents the control to be implemented over I/O parameters in response to signals received via RX 144 when device 130 is transmitting on TX/RX 142 and TX 124. Signals on RX 144 when device 130 is transmitting to device 110 will be metadata signals.

In one example, the metadata signals represent signals to track parameter information, such as information for PI (proportional integral) or PID (proportional integral derivative) settings, DFE settings, gain settings, and receiver voltage envelope settings, or other information. In one example, the unidirectional backward-facing signal lines can provide parameter control 114 information for settings for I/O for device 110 once the bus switches directions. In one example, the unidirectional backward-facing signal lines can provide parameter control 134 information for settings for I/O for device 130 once the bus switches directions.

A device can typically maintain I/O parameters for receive I/O when receiving a signal. Such operation is traditionally applied, where a receiver tracks incoming signals to adjust I/O parameters to maintain good signaling. It will be understood that with the unidirectional signal lines, device 110 and device 130 always have a receiving signal line. By having a receiving signal line, the devices can maintain the I/O for the receiving device, and use the information with the parameter controllers to apply configuration to the bidirectional signal lines (e.g., TX/RX 122 and TX/RX 142). In one example, the unidirectional lines can be used to track information for DQS drift.

FIG. 2 is a representation of an example of a data eye for a system having a reverse-facing data lane for I/O tracking. Diagram 200 represents a data eye diagram for an I/O interface of a device that interfaces with a bidirectional bus. Diagram 200 represents an example of a data eye diagram for an example of one or more of interfaces of interface 112 or of interface 132.

Diagram 200 illustrates data eye 210, which represents a shape of space within signal average 220. Signal average 220 represents averages for signaling. The space within signal average could be considered all of the area within the signal average, with the gray diamond indicating a target area to keep free of signals. The diamond has an eye width EW and an eye height EH. Outside of EW and EH, there are margins represented by the white space between data eye 210 and signal average 220. The white space can be referred to as a margin. Margin 230 illustrates a margin, which is a range between data eye 210 and signal average 220.

Data eye 210 is a data eye in reference to specific settings for I/O. Diagram 200 illustrates two signals as scenarios for data eye 210. Signal 222 is the dashed line. It can be observed that signal 222 is entirely within signal average 220, and thus can be properly received with the I/O settings. Signal 224 is the solid line. It can be observed that signal 224 is phase shifted to the right. Due to the shift, signal 224 has a rising edge outside of margin 230, within data eye 210. Thus, signal 224 violates data eye 210 and the signal will not be reliably read.

Diagram 200 illustrates the effects of various parameters that can be monitored and adjusted. VDD represents a receive high voltage. VSS represents a receive low voltage. VTT represents a center voltage between VDD and VSS. In one example, the I/O signals swing between VDD and VSS and can be terminated to VTT when termination is used. In one example, the swing between VDD and VSS can be adjusted.

Period 250 represents a nominal period of time between rising edge and falling edge of the signals. In one example, period 250 can be adjusted by changing receiver response. Slope 240 represents a slope of the rising edge. A similar slope can be monitored for the falling edge. Slope 240 can be referred to as the slew rate, or the change in voltage of the signal per unit time. In one example, slope 240 can be adjusted to respond to changing environmental conditions.

In one example, parameter control such as parameter control 114 or parameter control 134 of system 100 can adjust parameters by portions of the overall period to allow the I/O circuitry to correctly track the signals. For example, the I/O circuitry could adjust phase by X picoseconds by adjusting one or more parameters.

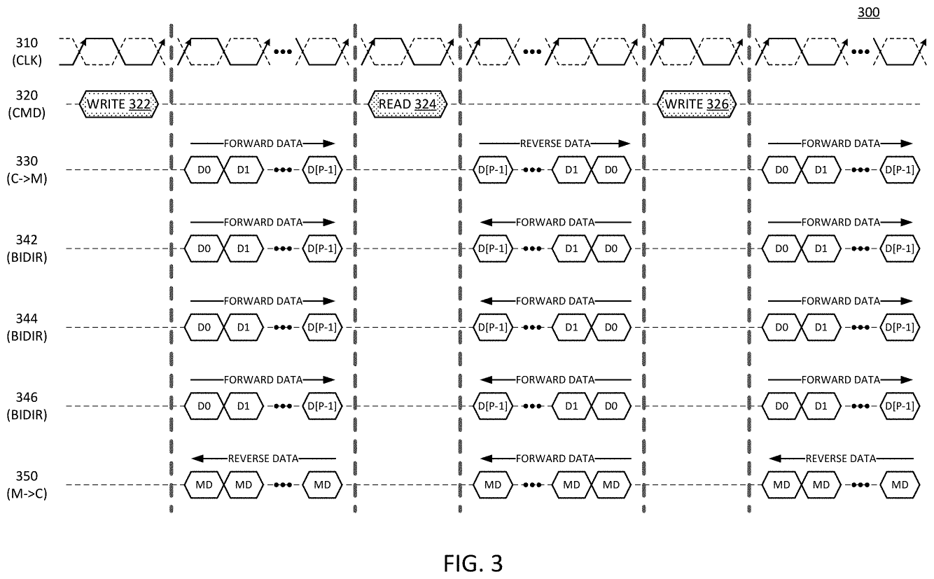

FIG. 3 is a timing diagram of an example of communication over a data interface having a reverse-facing data lane for I/O tracking. Diagram 300 represents various signals for a system with two devices that share an N-bit bidirectional bus. Diagram 300 provides an example of a timing diagram for a system in accordance with system 100 of FIG. 1.

Signal 310 represents a clock signal (CLK), and is simply for reference. The specific numbers of clock cycles for an operation is not material. The dashed lines that cut across all signals represent time breaks, which can indicate a period of zero or more clock cycles. In the example of diagram 300, commands occur over a full clock cycle, and data is sent as one bit per clock edge (rising and falling edges, or double data rate). In one example, commands take two clock cycles, or two commands are needed to execute a single command operation. Such examples are not specifically illustrated in diagram 300.

Signal 320 represents a command (CMD) signal. In the example of diagram 300, the command could be sent from a memory controller to a memory device, based on the commands illustrated. It will be understood that other device pairs could implement a similar exchange over a bidirectional bus. For purposes of illustrating the additional signal line for the data bus, signal 320 illustrates a Write command (Write 322) followed by a Read command (Read 324), followed by a Write command (Write 326). The Write to Read transition (Write 322 to Read 324) will result in the bus flipping directions. The Read to Write transition (Read 324 to Write 326) will result in the bus flipping back. It will be understood that the commands simply illustrate the bus transition, and other commands and signals could be sent (including multiple Writes after the Write commands, or multiple Reads after the Read command) between transitions of the bus.

Signal 330 represents a signal line for a unidirectional signal from controller to memory (C->M). Signal 342, signal 344, and signal 346 represent bidirectional signal between the controller and the memory (BIDIR). The bidirectional signals will change direction when the bus flips, as explained below. Signal 350 represents a signal line for a unidirectional signal from memory to controller (M->C).

After Write 322, the controller sends data to the memory. Thus, signal 330, signal 342, signal 344, and signal 346 provide forward data from the controller to the memory. The data is represented as D0, D1, . . . D[P−1] for P bits of data to be sent on each line. Typically, the variable ‘N’ is used to indicate a number of bits sent over a line. However, P is used here because N has been previously used to indicate a number of signal lines. The use of different variables is simply to indicate that different numbers of signal lines and different numbers of bits could be used in an implementation. Diagram 300 could alternatively illustrate and be described as sending data D0, D1, . . . D[N−1], where N is not necessarily equal to the number of signal lines in the bus. Signal 350 is unidirectional in the reverse direction with respect to a memory write. Thus, signal 350 provides metadata (MD) in the reverse direction.

After Read 324, the memory sends data to the controller. Thus, signal 342, signal 344, signal 346, and signal 350 provide forward data from the memory to the controller. The data is represented as D0, D1, . . . D[P−1] for P bits of data to be sent on each line. Signal 330 is unidirectional in the reverse direction with respect to a memory read. Thus, signal 330 provides metadata (MD) in the reverse direction.

After Write 326, the controller again sends data to the memory. Thus, signal 330, signal 342, signal 344, and signal 346 again provide forward data from the controller to the memory, and signal 350 provides metadata (MD) in the reverse direction.

In one example, the metadata is random data. Even with random data, the transmitting device can prepare the configuration of its channel for receive when the bus flips direction. In one example, since the system will send data, the system sends usable metadata instead of random data. In one example, the usable metadata represents feedback bits that indicate information about one or more I/O configuration settings. In one example, the metadata signal includes information about only a single configuration setting. In one example, the metadata includes information about multiple configuration settings. When sending information about multiple configuration settings, the data about different settings could be sent in sequence. A protocol could be provided so the sender and receiver of the metadata can both understand what information is being sent. In one example, the metadata can include a feedback indicator or header for the metadata packet, followed by a metadata packet payload.

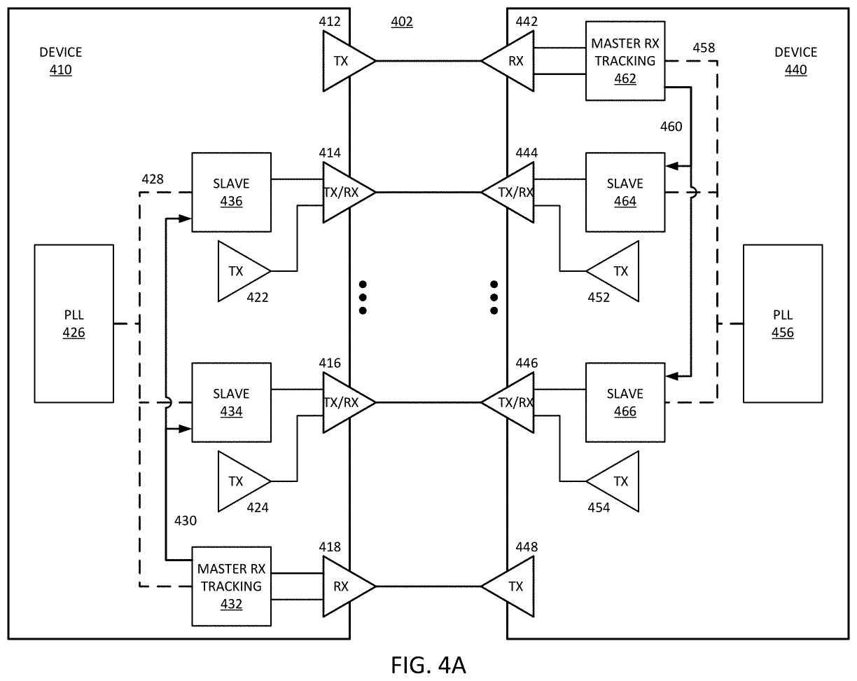

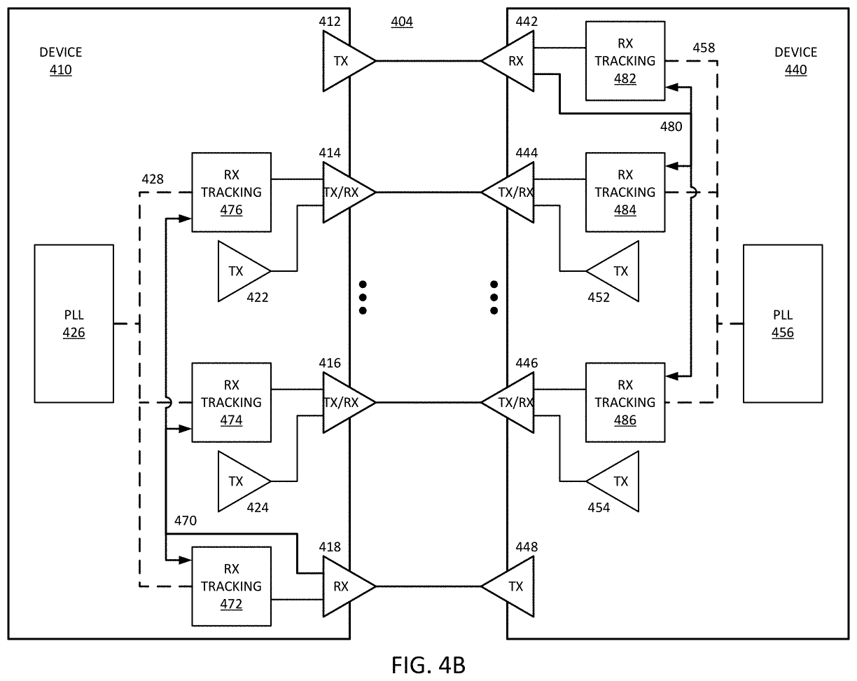

FIG. 4A is a block diagram of an example of a system having a reverse-facing data lane in a data interface with a master receive tracking circuit. System 402 provides an example of a system in accordance with system 100 of FIG. 1. System 402 includes device 410 and device 440, which are companion devices to communicate with each other over a bidirectional bus. System 402 does not specify the size of the bus, which can be any width for a practical system implementation.

Device 410 includes TX interface 412 as a unidirectional interface corresponding to RX interface 442 of device 440. Device 410 includes bidirectional interfaces TX/RX 414 and TX/RX 416, corresponding to bidirectional interfaces TX/RX 444 and TX/RX 446, respectively, of device 440. Device 410 includes RX interface 418 as a unidirectional interface corresponding to TX interface 448 of device 440. Thus, the bus includes N−1 bidirectional interfaces and two unidirectional interfaces, with one unidirectional interface pointing each direction.

In one example, device 410 includes master RX tracking 432, coupled to RX interface 418. Master RX tracking 432 tracks the proper I/O settings based on reverse metadata received over the RX channel when device 410 is the transmitter. In one example, master RX tracking 432 provides control to slave 434 for TX/RX 416 and slave 436 for TX/RX 414. In one example, in response to the metadata, master RX tracking 432 generates settings for receive, which it sends to slave 434 and slave 436. In one example, slave 434 and slave 436 apply the master settings with a slave offset. The slave offset can be, for example, an offset known to slave 434 or slave 436 relative to master RX tracking 432. Such an offset can be known if master RX tracking 432 provides both its previous settings and the current settings, or simply provides the offset.

In one example, slave 434 and slave 436 apply the master settings just as applied for RX interface 418. Then, slave 434 and slave 436 can locally adjust their respective TX/RX 414 and TX/RX 416 to adjust the master setting to local I/O for the specific I/O interface. Thus, a slave interface can initially apply the master I/O settings and adjust the settings locally for the specific bidirectional interface based on operation of that interface. PLL 426 represents control circuitry of device 410 to adjust the I/O interfaces for the receive interfaces. The control circuitry can adjust the phase of the strobe versus the receive data signal, adjust voltage, gain, DFE tap settings, clock frequency, or other settings, or a combination of settings.

In one example, PLL 426 adjusts the settings based on configuration monitored with RX 418 by master RX tracking 432. Similarly, PLL 456 of device 440 can perform similar functions for device 440. In one example, PLL 456 adjusts settings based on configuration monitored with RX 442 by master RX tracking 462. Device 440 illustrates master RX tracking 462, slave 464, and slave 466, which can be described as above with respect to similar components of device 410. In one example, PLL 426 provides timing control for all lanes interfaced by device 410. In one example, PLL 456 provides timing control for all lanes interfaced by device 440.

Device 410 illustrates TX 422 coupled to TX/RX 414 and TX 424 coupled to TX/RX 416. TX 422 and TX 424 represent transmit sources for the bidirectional interfaces. The data paths of the interfaces are not specifically shown in system 402, but it will be understood that when device 410 is the transmitter, TX 422 and TX 424 will be active to send data on TX/RX 414 and TX/RX 416, respectively. When device 410 is a receiver, the configuration of the bidirectional interfaces is controlled by slave 434 and slave 436, and the transmit paths are not active.

Device 440 illustrates TX 452 coupled to TX/RX 444 and TX 454 coupled to TX/RX 446. TX 452 and TX 454 represent transmit sources for the bidirectional interfaces. The data paths of the interfaces are not specifically shown in system 402, but it will be understood that when device 440 is the transmitter, TX 452 and TX 454 will be active to send data on TX/RX 444 and TX/RX 446, respectively. When device 440 is a receiver, the configuration of the bidirectional interfaces is controlled by slave 464 and slave 466, and the transmit paths are not active.

Path 428 represents the timing or signaling control provided by PLL 426 or other I/O signaling control circuitry for device 410. Path 430 represents the communication by master RX tracking 432 to slave 434 and slave 436. Path 458 represents the timing or signaling control provided by PLL 456 or other I/O signaling control circuitry for device 440. Path 460 represents the communication by master RX tracking 462 to slave 464 and slave 466.

In general, the unidirectional lines can be used for receiving metadata when a device is the transmitter. In one example, the metadata can be used to train a master I/O (input/output) setting. For example, the metadata can be used to train an I/O power, I/O speed, I/O voltage, or I/O phase, or to train a decision feedback equalizer (DFE) circuit.

FIG. 4B is a block diagram of an example of a system having a reverse-facing data lane in a data interface with each receiver having a receive tracking circuit. System 404 provides an example of a system in accordance with system 100 of FIG. 1. System 404 provides an alternative example to system 402. Whereas system 402 provides a master tracking circuit for all RX interfaces, system 404 provides metadata to separate RX interface tracking circuits for separate control.

System 404 includes device 410 and device 440, which are described above. All components of system 404 that are present in system 402 can operation similar to what is described above, with the following alternatives.

In one example, device 410 includes RX tracking 472 for RX interface 418, RX tracking 474 for TX/RX 416, and RX tracking 476 for TX/RX 414. RX tracking 472, RX tracking 474, and RX tracking 476 track the proper I/O settings based on reverse metadata received over the RX channel of RX interface 418 when device 410 is the transmitter. Rather than having a master tracking circuit, each interface can have a separate tracking circuit. The tracking circuits compute I/O configuration for the bus at its state when the bus switches directions.

In one example, device 440 includes RX tracking 482 for RX interface 442, RX tracking 484 for TX/RX 444, and RX tracking 486 for TX/RX 446. RX tracking 482, RX tracking 484, and RX tracking 486 track the proper I/O settings based on reverse metadata received over the RX channel of RX interface 442 when device 440 is the transmitter.

Path 428 represents the timing or signaling control provided by PLL 426 or other I/O signaling control circuitry for device 410. Path 470 represents the path of metadata to the separate tracking circuits for the separate I/O interfaces, including RX tracking 472, RX tracking 474, and RX tracking 476. Path 458 represents the timing or signaling control provided by PLL 456 or other I/O signaling control circuitry for device 440. Path 480 represents the path of metadata to the separate tracking circuits for the separate I/O interfaces, including RX tracking 482, RX tracking 484, and RX tracking 486.

Whether by master and slave offset, master tracking and slave adjustment, or separate tracking control for each interface, in general, the unidirectional lines can be used for receiving metadata when a device is the transmitter. In one example, the metadata can be used to train a master I/O (input/output) setting. For example, the metadata can be used to train an I/O power, I/O speed, I/O voltage, or I/O phase, or to train a decision feedback equalizer (DFE) circuit.

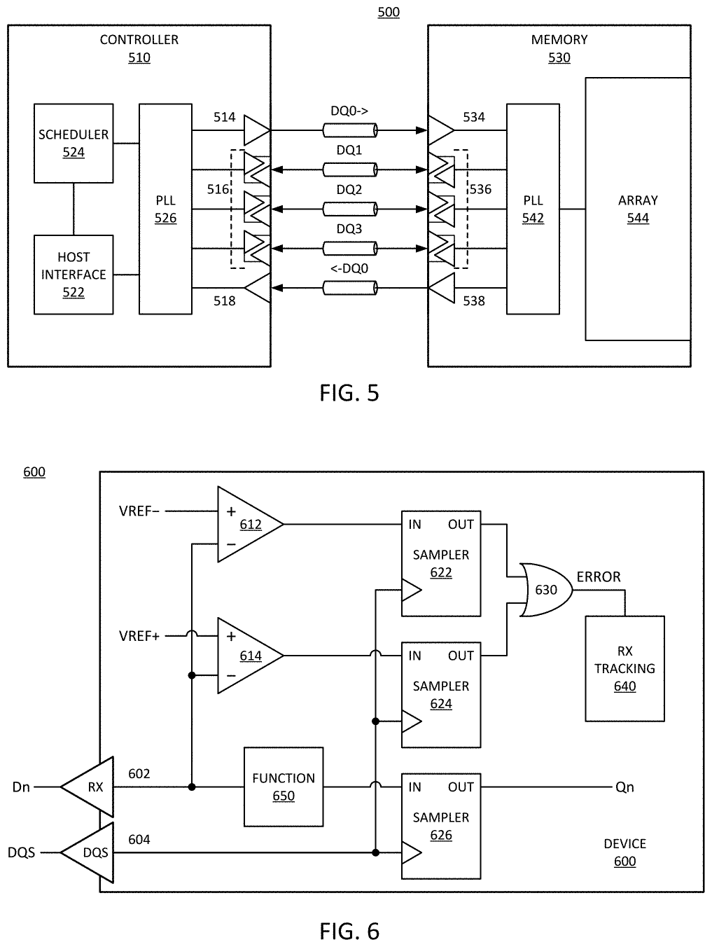

FIG. 5 is a block diagram of an example of a memory subsystem having a reverse-facing data lane for I/O tracking. System 500 includes controller 510 and memory 530, which communicate over a high-speed, single-ended, bidirectional data bus. Controller 510 represents the host system, or the system in which memory 530 is incorporated. Memory 530 main memory or operational system memory.

Memory 530 represents a memory device with a x4 DQ interface. It will be understood that memory 530 has interfaces to 5 signal lines, which could alternatively be interpreted as a x5 DQ interface. However, for purposes of the number of DQ signal lines, memory 530 can be understood to connect to 4 DQ signals, DQ[0:3].

In one example, one of the DQ signal lines will be split for the forward and reverse directions of the DQ bus. System 500 illustrates DQ0 as being split among the two unidirectional signal lines. It will be understood that any of the DQ signals could be split among the unidirectional signal lines. Putting DQ0 onto the unidirectional lines could provide a better DQ0 link because the signal from controller 510 to memory 530 is always the same direction, which can improve configuration. Such a feature could be an advantage for functions such as per device addressability (PDA) or other functions that utilize DQ0 for signaling.

Controller 510 can be coupled to multiple memory devices in accordance with memory 530. Only a single memory 530 is illustrated in system 500. Controller 510 would typically have different DQ links to each memory device.

In one example, controller 510 includes unidirectional connection 514 to a C->M (controller to memory) DQ0, which connects to connection 534 of memory 530. In one example, controller 510 includes bidirectional connections 516 to DQ[1:3], which connect to connections 536 of memory 530. It will be understood that for more than 4 DQ signals, there will be more bidirectional signal lines and associated connections. In one example, controller 510 includes unidirectional connection 518 to an M->C (memory to controller) D00, which connects to connection 538 of memory 530. C->M DQ0 and M->C DQ0 together provide a bidirectional DQ link for DQ0.

In one example, PLL 526 provides phase timing control for connection 514, connections 516, and connection 518 of controller 510. In one example, PLL 542 provides phase timing control for connection 534, connections 536, and connection 538 of memory 530. PLL 526 and PLL 542 can adjust the signaling configuration for receivers for controller 510 and memory 530, respectively.

In one example, controller 510 includes host interface 522, which represents an interface with the host processor that generates a request for data from memory 530. The host processor can be a primary processor that executes the host operating system (OS), or a graphics processor, or peripheral processor. Scheduler 524 of controller 510 represents a scheduler to send out host commands and schedule the sending of data for write commands. In one example, received data can be provided to host interface 522 to send back to the requester. In one example, metadata received on connection 518 can be used by PLL 526 to configure receive interfaces of controller 510 in accordance with any description herein.

Memory 530 includes array 544, which represents a memory array for memory 530. Array 544 can be any memory technology used to support a high-speed memory subsystem. In response to a write command, memory 530 writes data to array 544. In response to a read command, memory 530 returns data from array 544. With a write command, memory 530 can provide metadata to controller 510 over DQ0 M->C. With a read command, controller 510 can provide metadata to memory 530 over DQ0 C->M.

FIG. 6 is a block diagram of a I/O receiver with I/O tracking. System 600 provides an example of a receiver circuit in accordance with system 100, system 402, system 404, or system 500. In one example, the circuitry of system 600 can provide receiver voltage envelope detection. In one example, the circuitry can be included in each receiver. In one example, the DQS signal is shared among different RX receive circuits.

System 600 includes path 602 to represent the data path and path 604 to represent the data strobe path. Path 602 is the path of the data (Dn) through the RX interface. The data can be processed and checked for the data eye. Path 604 is the path of the data strobe (DQS) through the DQS interface. DQS is a clock signal used to decode the data signal.

In one example, path 604 provides the DQS signal to sampler 626 to sample the data to receive the data signal. Sampler 626 can be implemented as a latch that triggers off the DQS signal. The data signal (Dn) is the input to sampler 626, and the output is Qn, which is buffered and then written to the memory array. In one example, if the RX interface is the unidirectional interface to receive metadata, the output Qn can be sent to RX tracking 640 if the metadata is useful data, or can be dropped if the metadata is dummy data.

In one example, path 604 provides the DQS signal to sampler 622 and to sampler 624. Sampler 622 and sampler 624 can be implemented as latches that triggers off the DQS signal. Sampler 622 and sampler 624 provide envelope detection for the data signal, to ensure that the data eye is maintained, and the data can be properly decoded.

The data signal (Dn) is compared to positive and negative references (VREF+ and VREF−, respectively). Comparator 612 receives Dn to compare against VREF−, and comparator 614 receives Dn to compare against VREF+. The output of comparator 612 is provided as the input to sampler 622. The output of comparator 614 is provided as the input to sampler 624. In one example, the outputs of sampler 622 and sampler 624 are compared with an XOR (exclusive OR) gate 630 to generate an ERROR signal. The ERROR signal can be provided to RX tracking 640. If the sampling of the data signal violates the data eye, system 600 should generate the ERROR signal, which RX tracking 640 can use to adjust I/O configuration to improve the I/O.

In one example, function 650 represents one or more functions to apply to the received data signal. Function 650 can represent one or more circuit elements or circuitry to perform one or more adjustments to the incoming signal. Functions that can be represented by function 650 can includes DFE, write leveling, internal write signals, refresh synchronization, ODT, or other functions, or a combination.

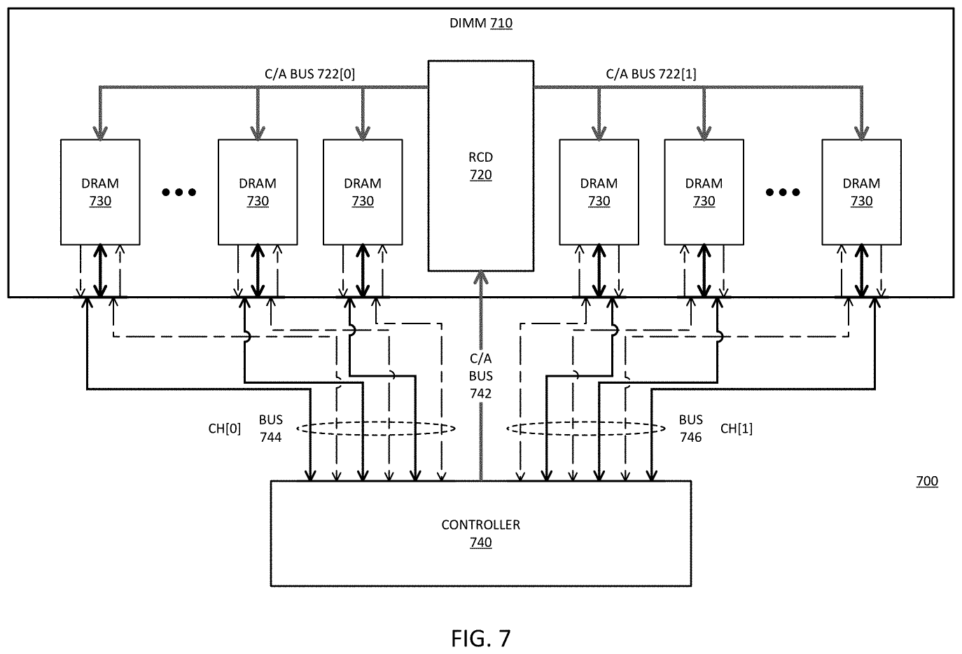

FIG. 7 is a block diagram of an example of a memory module with memory devices having a reverse-facing data lane for I/O tracking. System 700 provides an example of a system in accordance with system 100, system 402, system 404, system 500, or system 600. Prior descriptions focused on the connection of one memory device to the host controller; system 700 provides an example of a host controller connected to multiple memory devices.

System 700 illustrates one embodiment of a system with memory devices that share a control bus (C/A (command/address) bus 742) and a data bus, which is illustrated as split into bus 744 for Channel 0 (CH[0]) and bus 746 for Channel 1 (CH[1]). The memory devices are represented as DRAM (dynamic random access memory) devices 730. In one example, the two separate channels share C/A bus 742. In one example, the separate channels will have separate C/A buses. DRAM devices 730 can be individually accessed with device specific commands, and can be accessed in parallel with parallel commands.

RCD (registered clock driver or registering clock driver) 720 represents a controller for DIMM (dual inline memory module) 710. It will be understood that the controller represented by RCD 720 is different from the host controller or memory controller represented by controller 740. Likewise, RCD 720 is different from an on-chip or on-die controller that is included on the DRAM devices. In one example, RCD 720 receives information from the host (such as controller 740) and buffers the signals from controller 740 to the various DRAM devices 730. If all DRAM devices 730 were directly connected to controller 740, the loading on the signal lines would degrade high speed signaling capability. By buffering the input signals from controller 740, the controller only sees the load of RCD 720, which can then control the timing and signaling to DRAM devices 730.

In one example, RCD 720 controls the signals to the DRAM devices of Channel 0 through C/A bus 722[0], and controls the signals to DRAM devices of Channel 1 through C/A bus 722[0]. In one example, RCD 720 has independent command ports for separate channels. In one example, the data buses are also routed through RCD 720, which is not specifically shown. In one example, DIMM 710 includes data buffers (not illustrated) to buffer the data bus signals between DRAM devices 730 and controller 740.

C/A bus 722[0] AND C/A bus 722[1] (collectively, C/A buses 722) are typically unilateral buses or unidirectional buses to carry command and address information from controller 740 to DRAM devices 730. Thus, C/A buses 722 can be multi-drop buses. Data buses are traditionally bidirectional, point-to-point buses.

In one example, DRAM device 730 include interfaces to data buses having a unidirectional signal line from controller 740 to the DRAM device, another unidirectional signal line from the DRAM device to controller 740, and multiple bidirectional signal lines between the DRAM device and controller 740. Such an interface can be in accordance with any example described. The unidirectional and bidirectional data bus signal lines can be directly connected between memory device and host controller, routed through RCD 720, or routed through data buffers.

In accordance with other descriptions herein, in one example, DRAM devices 730 and controller 740 exchange metadata in the reverse data direction to enable the preparation of the receiver for a switch of directions of the data bus. It will be understood that in system 700, the state of data bus 744 will not necessarily be identical to the state of data bus 746, even though both are connected between controller 740 and DIMM 710. Additionally, the different buses may be pointing different directions at different times, depending on the read and write patterns of the workloads to the different channels. Additionally, each DRAM device 730, even within the same channel, may experience different conditions on its separate data or DQ signal lines within the same data bus. Thus, the reverse-direction signal lines allow each channel to adjust independent of each other to different conditions, and each DRAM device 730 to adjust independent of each other to different conditions. Such control enables each device to adjust its I/O signaling configuration for best performance at the individual device.

It will be understood that with two unidirectional signal lines connecting to each of M DRAM devices 730 per channel, there can be an additional M signal lines to be routed between controller 740 and DIMM 710, per channel. The additional signal lines have an associated cost. The additional signal lines also provided advantages in reduced signaling delay as the data bus switches directions in response to changes between read and write commands.

In one example, DIMM 710 includes redundant DRAM devices 730 to implement ECC (error checking and correction). Such redundant DRAM devices will also implement the additional signal lines in the buses to enable faster switching.

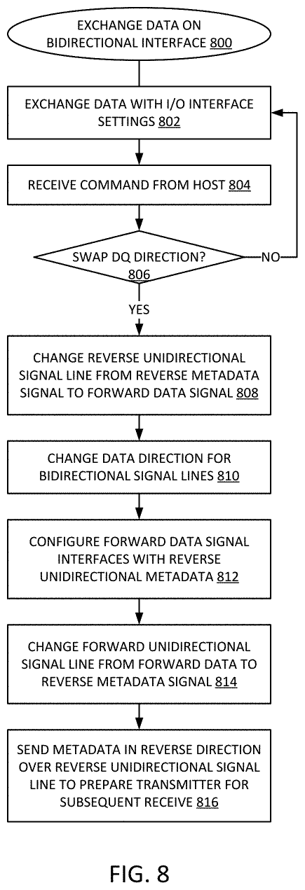

FIG. 8 is a flow diagram of an example of a process for bidirectional data transfer in a system with a reverse-facing data lane. Process 800 provides an example of a process that can be executed by a memory device and a controller device to exchange data on a bidirectional interface. An alternative implementation of process 800 can replace the swapping of the data direction based on a trigger instead of the write or read command. Thus, one of skill in the art will understand how to implement process 800 for exchanging data on a bidirectional interface in system configurations with devices other than memory and controller.

In one example, the memory device and controller exchange data with I/O interface settings that have been set by configuring the interface, at 802. In one example, the host sends a subsequent command to the memory device, at 804. If the command is a command that sends data the same direction as currently being sent, there is no change to the direction on the data bus. If the command is a command that reverses the direction of data flow, the command will trigger the data bus to flip.

If the command does not trigger a swap of data (DQ) direction, at 806 NO branch, the controller and memory device can continue to exchange data with the I/O interface settings, at 802. In one example, whichever device is the receiver in that mode may continue to update receive configuration settings based on data received. In one example, the command triggers a swap of the data direction, at 806 YES branch. For example, if the memory device is sending data to the controller in response to one or more read commands, the controller could send a write command, which would cause the bus to be driven by the controller to send data to the memory device for the write.

In one example, when the data flow swaps direction, the devices change the use of the reverse unidirectional signal line from a reverse metadata signal transmission to a forward data signal, at 808. The devices change the data direction for bidirectional signal line interfaces, changing receivers to drivers or vice-versa, at 810. In one example, the device that was the transmitter configures the receivers for the forward data signal interfaces based on the reverse unidirectional metadata, at 812. In one example, the configuration is applied based on monitoring of the receive conditions based on the reverse-facing unidirectional interface.

The devices change the use of the forward unidirectional signal line interface from forward data to reverse metadata signaling, at 814. Thus, the device that was transmitting forward data on the unidirectional signal line changes to the receiver device, and continues to transmit on the unidirectional signal line, but now with reverse metadata instead of user data (data to be written to the memory array if the controller is changing from the transmitter to the receiver, or data from the memory array if the memory device is changing from the transmitter to the receiver). In one example, the device that is now the receiver of user data sends metadata in the reverse direction over the reverse unidirectional signal line to monitor the receive interface to prepare the device that is currently the transmitter to become the receiver with the next data bus direction switch, at 816.

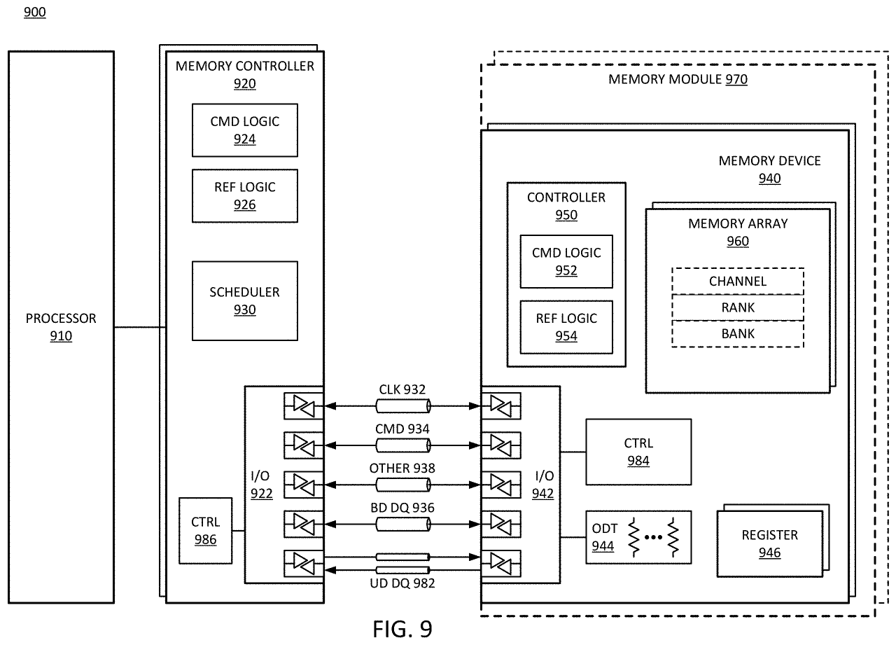

FIG. 9 is a block diagram of an example of a memory subsystem in which bidirectional data transfer with a reverse-facing data lane can be implemented. System 900 includes a processor and elements of a memory subsystem in a computing device. System 900 provides an example of a system in accordance with system 100, system 402, system 404, system 500, system 600, or system 700.

I/O 922 of memory controller 920 includes interfaces to bidirectional data (BD DQ) lines 936. I/O 942 of memory device 940 includes interfaces to BD DQ lines 936. In one example, I/O 922 includes interfaces to unidirectional data (UD DQ) lines 982. In one example, I/O 942 includes interfaces to UD DQ lines 982. The unidirectional lines are represented in system 900 with an arrow pointing only one direction. The unidirectional lines are used to monitor receive configuration for a transmitting device, which enables the transmitting device to quickly transition to a receiving device when the data bus direction changes. The operation can be in accordance with any example described.

In one example, memory controller 920 includes control (CTRL) 986 to represent circuitry at the controller that will adjust configuration of the receive I/O based on reverse metadata. In one example, control 986 includes master and slave control. In one example, control 986 includes separate configuration control for each I/O interface. In one example, memory device 940 includes control (CTRL) 984 to represent circuitry at the memory that will adjust configuration of the receive I/O based on reverse metadata. In one example, control 984 includes master and slave control. In one example, control 984 includes separate configuration control for each I/O interface.

Processor 910 represents a processing unit of a computing platform that may execute an operating system (OS) and applications, which can collectively be referred to as the host or the user of the memory. The OS and applications execute operations that result in memory accesses. Processor 910 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 900 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR4 (DDR version 4, JESD79-4, originally published in September 2012 by JEDEC), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, currently in discussion by JEDEC), LPDDR5 (LPDDR version 5, JESD209-5, originally published by JEDEC in February 2019), HBM2 ((HBM version 2), currently in discussion by JEDEC), or others or combinations of memory technologies, and technologies based on derivatives or extensions of such specifications.

In addition to, or alternatively to, volatile memory, in one example, reference to memory devices can refer to a nonvolatile memory device whose state is determinate even if power is interrupted to the device. In one example, the nonvolatile memory device is a block addressable memory device, such as NAND or NOR technologies. Thus, a memory device can also include a future generation nonvolatile devices, such as a three dimensional crosspoint memory device, other byte addressable nonvolatile memory devices. A memory device can include a nonvolatile, byte addressable media that stores data based on a resistive state of the memory cell, or a phase of the memory cell. In one example, the memory device can use chalcogenide phase change material (e.g., chalcogenide glass). In one example, the memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

Memory controller 920 represents one or more memory controller circuits or devices for system 900. Memory controller 920 represents control logic that generates memory access commands in response to the execution of operations by processor 910. Memory controller 920 accesses one or more memory devices 940. Memory devices 940 can be DRAM devices in accordance with any referred to above. In one example, memory devices 940 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 920 manages a separate memory channel, although system 900 can be configured to have multiple channels managed by a single controller, or to have multiple controllers on a single channel. In one example, memory controller 920 is part of host processor 910, such as logic implemented on the same die or implemented in the same package space as the processor.

Memory controller 920 includes I/O interface logic 922 to couple to a memory bus, such as a memory channel as referred to above. I/O interface logic 922 (as well as I/O interface logic 942 of memory device 940) can include pins, pads, connectors, signal lines, traces, or wires, or other hardware to connect the devices, or a combination of these. I/O interface logic 922 can include a hardware interface. As illustrated, I/O interface logic 922 includes at least drivers/transceivers for signal lines. Commonly, wires within an integrated circuit interface couple with a pad, pin, or connector to interface signal lines or traces or other wires between devices. I/O interface logic 922 can include drivers, receivers, transceivers, or termination, or other circuitry or combinations of circuitry to exchange signals on the signal lines between the devices. The exchange of signals includes at least one of transmit or receive. While shown as coupling I/O 922 from memory controller 920 to I/O 942 of memory device 940, it will be understood that in an implementation of system 900 where groups of memory devices 940 are accessed in parallel, multiple memory devices can include I/O interfaces to the same interface of memory controller 920. In an implementation of system 900 including one or more memory modules 970, I/O 942 can include interface hardware of the memory module in addition to interface hardware on the memory device itself. Other memory controllers 920 will include separate interfaces to other memory devices 940.

The bus between memory controller 920 and memory devices 940 can be implemented as multiple signal lines coupling memory controller 920 to memory devices 940. The bus may typically include at least clock (CLK) 932, command/address (CMD) 934, and write data (DQ) and read data (DQ), and zero or more other signal lines 938. In one example, a bus or connection between memory controller 920 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 900 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 920 and memory devices 940. An example of a serial bus technology is 8B10B encoding and transmission of high-speed data with embedded clock over a single differential pair of signals in each direction. In one example, CMD 934 represents signal lines shared in parallel with multiple memory devices. In one example, multiple memory devices share encoding command signal lines of CMD 934, and each has a separate chip select (CS_n) signal line to select individual memory devices.

It will be understood that in the example of system 900, the bus between memory controller 920 and memory devices 940 includes a subsidiary command bus CMD 934 and a subsidiary bus to carry the write and read data, DQ. In one example, the data bus can include bidirectional data (BD DQ) lines 936 for read data and for write/command data. In another example, the subsidiary bus can include unidirectional write signal lines for write and data from the host to memory, and can include unidirectional lines for read data from the memory to the host. The unidirectional lines are represented at UD DQ 982, and can include reverse-facing unidirectional lines in addition to the bidirectional lines of BD DQ 936. In accordance with the chosen memory technology and system design, other signals 938 may accompany a bus or sub bus, such as strobe lines DQS. Based on design of system 900, or implementation if a design supports multiple implementations, the data bus can have more or less bandwidth per memory device 940. For example, the data bus can support memory devices that have either a x4 interface, a x8 interface, a x16 interface, or other interface. The convention “xW,” where W is an integer that refers to an interface size or width of the interface of memory device 940, which represents a number of signal lines to exchange data with memory controller 920. The interface size of the memory devices is a controlling factor on how many memory devices can be used concurrently per channel in system 900 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 940 and memory controller 920 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 940 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 940 represent memory resources for system 900. In one example, each memory device 940 is a separate memory die. In one example, each memory device 940 can interface with multiple (e.g., 2) channels per device or die. Each memory device 940 includes I/O interface logic 942, which has a bandwidth determined by the implementation of the device (e.g., x16 or x8 or some other interface bandwidth). I/O interface logic 942 enables the memory devices to interface with memory controller 920. I/O interface logic 942 can include a hardware interface, and can be in accordance with I/O 922 of memory controller, but at the memory device end. In one example, multiple memory devices 940 are connected in parallel to the same command and data buses. In another example, multiple memory devices 940 are connected in parallel to the same command bus, and are connected to different data buses. For example, system 900 can be configured with multiple memory devices 940 coupled in parallel, with each memory device responding to a command, and accessing memory resources 960 internal to each. For a Write operation, an individual memory device 940 can write a portion of the overall data word, and for a Read operation, an individual memory device 940 can fetch a portion of the overall data word. The remaining bits of the word will be provided or received by other memory devices in parallel.

In one example, memory devices 940 are disposed directly on a motherboard or host system platform (e.g., a PCB (printed circuit board) on which processor 910 is disposed) of a computing device. In one example, memory devices 940 can be organized into memory modules 970. In one example, memory modules 970 represent dual inline memory modules (DIMMs). In one example, memory modules 970 represent other organization of multiple memory devices to share at least a portion of access or control circuitry, which can be a separate circuit, a separate device, or a separate board from the host system platform. Memory modules 970 can include multiple memory devices 940, and the memory modules can include support for multiple separate channels to the included memory devices disposed on them. In another example, memory devices 940 may be incorporated into the same package as memory controller 920, such as by techniques such as multi-chip-module (MCM), package-on-package, through-silicon via (TSV), or other techniques or combinations. Similarly, in one example, multiple memory devices 940 may be incorporated into memory modules 970, which themselves may be incorporated into the same package as memory controller 920. It will be appreciated that for these and other implementations, memory controller 920 may be part of host processor 910.

Memory devices 940 each include one or more memory arrays 960. Memory array 960 represents addressable memory locations or storage locations for data. Typically, memory array 960 is managed as rows of data, accessed via wordline (rows) and bitline (individual bits within a row) control. Memory array 960 can be organized as separate channels, ranks, and banks of memory. Channels may refer to independent control paths to storage locations within memory devices 940. Ranks may refer to common locations across multiple memory devices (e.g., same row addresses within different devices) in parallel. Banks may refer to sub-arrays of memory locations within a memory device 940. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 940 include one or more registers 944. Register 944 represents one or more storage devices or storage locations that provide configuration or settings for the operation of the memory device. In one example, register 944 can provide a storage location for memory device 940 to store data for access by memory controller 920 as part of a control or management operation. In one example, register 944 includes one or more Mode Registers. In one example, register 944 includes one or more multipurpose registers. The configuration of locations within register 944 can configure memory device 940 to operate in different “modes,” where command information can trigger different operations within memory device 940 based on the mode. Additionally or in the alternative, different modes can also trigger different operation from address information or other signal lines depending on the mode. Settings of register 944 can indicate configuration for I/O settings (e.g., timing, termination or ODT (on-die termination) 946, driver configuration, or other I/O settings).

In one example, memory device 940 includes ODT 946 as part of the interface hardware associated with I/O 942. ODT 946 can be configured as mentioned above, and provide settings for impedance to be applied to the interface to specified signal lines. In one example, ODT 946 is applied to DQ signal lines. In one example, ODT 946 is applied to command signal lines. In one example, ODT 946 is applied to address signal lines. In one example, ODT 946 can be applied to any combination of the preceding. The ODT settings can be changed based on whether a memory device is a selected target of an access operation or a non-target device. ODT 946 settings can affect the timing and reflections of signaling on the terminated lines. Careful control over ODT 946 can enable higher-speed operation with improved matching of applied impedance and loading. ODT 946 can be applied to specific signal lines of I/O interface 942, 922 (for example, ODT for DQ lines or ODT for CA lines), and is not necessarily applied to all signal lines.

Memory device 940 includes controller 950, which represents control logic within the memory device to control internal operations within the memory device. For example, controller 950 decodes commands sent by memory controller 920 and generates internal operations to execute or satisfy the commands. Controller 950 can be referred to as an internal controller, and is separate from memory controller 920 of the host. Controller 950 can determine what mode is selected based on register 944, and configure the internal execution of operations for access to memory resources 960 or other operations based on the selected mode. Controller 950 generates control signals to control the routing of bits within memory device 940 to provide a proper interface for the selected mode and direct a command to the proper memory locations or addresses. Controller 950 includes command logic 952, which can decode command encoding received on command and address signal lines. Thus, command logic 952 can be or include a command decoder. With command logic 952, memory device can identify commands and generate internal operations to execute requested commands.

Referring again to memory controller 920, memory controller 920 includes command (CMD) logic 924, which represents logic or circuitry to generate commands to send to memory devices 940. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 940, memory controller 920 can issue commands via I/O 922 to cause memory device 940 to execute the commands. In one example, controller 950 of memory device 940 receives and decodes command and address information received via I/O 942 from memory controller 920. Based on the received command and address information, controller 950 can control the timing of operations of the logic and circuitry within memory device 940 to execute the commands. Controller 950 is responsible for compliance with standards or specifications within memory device 940, such as timing and signaling requirements. Memory controller 920 can implement compliance with standards or specifications by access scheduling and control.

Memory controller 920 includes scheduler 930, which represents logic or circuitry to generate and order transactions to send to memory device 940. From one perspective, the primary function of memory controller 920 could be said to schedule memory access and other transactions to memory device 940. Such scheduling can include generating the transactions themselves to implement the requests for data by processor 910 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 920 typically includes logic such as scheduler 930 to allow selection and ordering of transactions to improve performance of system 900. Thus, memory controller 920 can select which of the outstanding transactions should be sent to memory device 940 in which order, which is typically achieved with logic much more complex that a simple first-in first-out algorithm. Memory controller 920 manages the transmission of the transactions to memory device 940, and manages the timing associated with the transaction. In one example, transactions have deterministic timing, which can be managed by memory controller 920 and used in determining how to schedule the transactions with scheduler 930.

In one example, memory controller 920 includes refresh (REF) logic 926. Refresh logic 926 can be used for memory resources that are volatile and need to be refreshed to retain a deterministic state. In one example, refresh logic 926 indicates a location for refresh, and a type of refresh to perform. Refresh logic 926 can trigger self-refresh within memory device 940, or execute external refreshes which can be referred to as auto refresh commands) by sending refresh commands, or a combination. In one example, controller 950 within memory device 940 includes refresh logic 954 to apply refresh within memory device 940. In one example, refresh logic 954 generates internal operations to perform refresh in accordance with an external refresh received from memory controller 920. Refresh logic 954 can determine if a refresh is directed to memory device 940, and what memory resources 960 to refresh in response to the command.

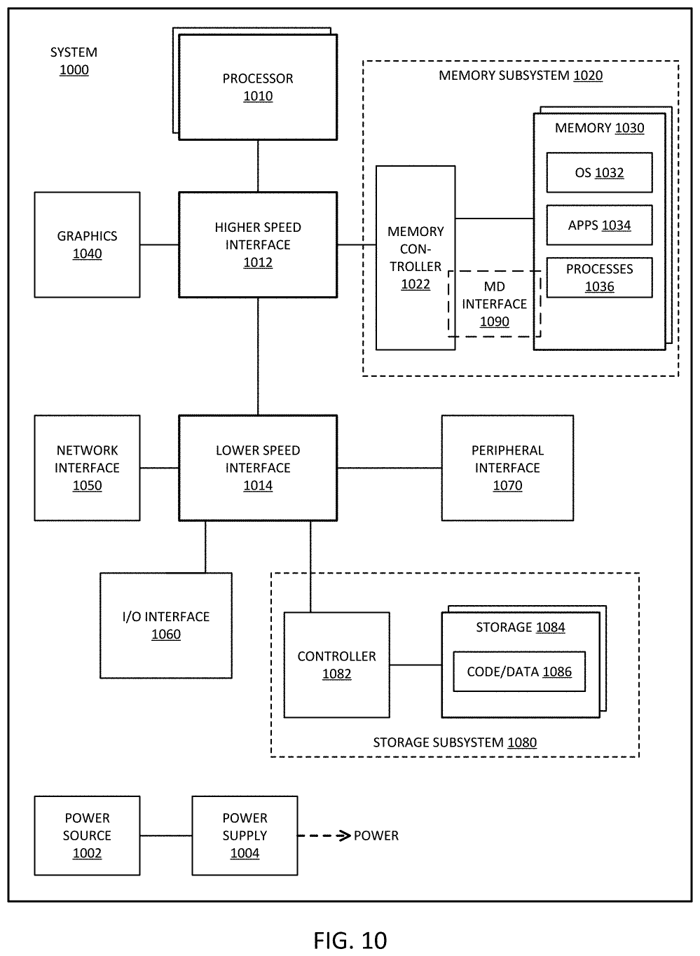

FIG. 10 is a block diagram of an example of a computing system in which bidirectional data transfer with a reverse-facing data lane can be implemented. System 1000 represents a computing device in accordance with any example herein, and can be a laptop computer, a desktop computer, a tablet computer, a server, a gaming or entertainment control system, embedded computing device, or other electronic device. System 1000 provides an example of a system in accordance with system 100, system 402, system 404, system 500, system 600, or system 700.

In one example, memory subsystem 1020 includes metadata (MD) interface 1090. Metadata interface 1090 represents a high-speed, bidirectional data interface in accordance with any example described. Metadata interface 1090 includes N−1 bidirectional data interfaces, a unidirectional interface from memory controller 1022 to memory 1030, and a unidirectional interface from memory 1030 to memory controller 1022. The unidirectional interfaces provide the Nth bit for an N-bit data bus in the forward direction, while also maintaining a reverse-facing metadata lane to monitor receive configuration. The operation of metadata interface 1090 can be in accordance with any operation of a bus with bidirectional and unidirectional lanes described.

System 1000 includes processor 1010 can include any type of microprocessor, central processing unit (CPU), graphics processing unit (GPU), processing core, or other processing hardware, processor device, or a combination, to provide processing or execution of instructions for system 1000. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or a combination of such devices. Processor 1010 can be considered a host processor device for system 1000.

In one example, system 1000 includes interface 1012 coupled to processor 1010, which can represent a higher speed interface or a high throughput interface for system components that need higher bandwidth connections, such as memory subsystem 1020 or graphics interface components 1040. Interface 1012 represents an interface circuit, which can be a standalone component or integrated onto a processor die. Interface 1012 can be integrated as a circuit onto the processor die or integrated as a component on a system on a chip. Where present, graphics interface 1040 interfaces to graphics components for providing a visual display to a user of system 1000. Graphics interface 1040 can be a standalone component or integrated onto the processor die or system on a chip. In one example, graphics interface 1040 can drive a high definition (HD) display or ultra high definition (UHD) display that provides an output to a user. In one example, the display can include a touchscreen display. In one example, graphics interface 1040 generates a display based on data stored in memory 1030 or based on operations executed by processor 1010 or both.

Memory subsystem 1020 represents the main memory of system 1000, and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, 3DXP (three-dimensional crosspoint), or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010, such as integrated onto the processor die or a system on a chip.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1000 includes interface 1014, which can be coupled to interface 1012. Interface 1014 can be a lower speed interface than interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, 3DXP, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example controller 1082 is a physical part of interface 1014 or processor 1010, or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one example, power supply 1004 includes an AC to DC (alternating current to direct current) adapter to plug into a wall outlet. Such AC power can be renewable energy (e.g., solar power) power source 1002. In one example, power source 1002 includes a DC power source, such as an external AC to DC converter. In one example, power source 1002 or power supply 1004 includes wireless charging hardware to charge via proximity to a charging field. In one example, power source 1002 can include an internal battery or fuel cell source.

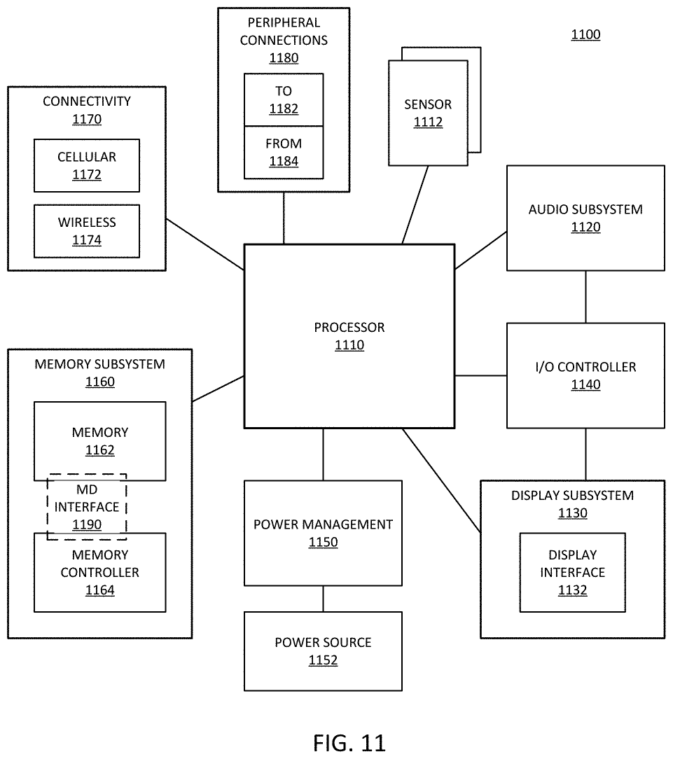

FIG. 11 is a block diagram of an example of a mobile device in which bidirectional data transfer with a reverse-facing data lane can be implemented. System 1100 represents a mobile computing device, such as a computing tablet, a mobile phone or smartphone, wearable computing device, or other mobile device, or an embedded computing device. It will be understood that certain of the components are shown generally, and not all components of such a device are shown in system 1100. System 1100 provides an example of a system in accordance with system 100, system 402, system 404, system 500, system 600, or system 700.

In one example, memory subsystem 1160 includes metadata (MD) interface 1190. Metadata interface 1190 represents a high-speed, bidirectional data interface in accordance with any example described. Metadata interface 1190 includes N−1 bidirectional data interfaces, a unidirectional interface from memory controller 1164 to memory 1162, and a unidirectional interface from memory 1162 to memory controller 1164. The unidirectional interfaces provide the Nth bit for an N-bit data bus in the forward direction, while also maintaining a reverse-facing metadata lane to monitor receive configuration. The operation of metadata interface 1190 can be in accordance with any operation of a bus with bidirectional and unidirectional lanes described.

System 1100 includes processor 1110, which performs the primary processing operations of system 1100. Processor 1110 can include one or more physical devices, such as microprocessors, application processors, microcontrollers, programmable logic devices, or other processing means or processor devices. Processor 1110 can be considered a host processor device for system 1100. The processing operations performed by processor 1110 include the execution of an operating platform or operating system on which applications and device functions are executed. The processing operations include operations related to I/O (input/output) with a human user or with other devices, operations related to power management, operations related to connecting system 1100 to another device, or a combination. The processing operations can also include operations related to audio I/O, display I/O, or other interfacing, or a combination. Processor 1110 can execute data stored in memory. Processor 1110 can write or edit data stored in memory.

In one example, system 1100 includes one or more sensors 1112. Sensors 1112 represent embedded sensors or interfaces to external sensors, or a combination. Sensors 1112 enable system 1100 to monitor or detect one or more conditions of an environment or a device in which system 1100 is implemented. Sensors 1112 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 1112 can also include sensors for biometric systems such as fingerprint recognition systems, face detection or recognition systems, or other systems that detect or recognize user features. Sensors 1112 should be understood broadly, and not limiting on the many different types of sensors that could be implemented with system 1100. In one example, one or more sensors 1112 couples to processor 1110 via a frontend circuit integrated with processor 1110. In one example, one or more sensors 1112 couples to processor 1110 via another component of system 1100.

In one example, system 1100 includes audio subsystem 1120, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into system 1100, or connected to system 1100. In one example, a user interacts with system 1100 by providing audio commands that are received and processed by processor 1110.

Display subsystem 1130 represents hardware (e.g., display devices) and software components (e.g., drivers) that provide a visual display for presentation to a user. In one example, the display includes tactile components or touchscreen elements for a user to interact with the computing device. Display subsystem 1130 includes display interface 1132, which includes the particular screen or hardware device used to provide a display to a user. In one example, display interface 1132 includes logic separate from processor 1110 (such as a graphics processor) to perform at least some processing related to the display. In one example, display subsystem 1130 includes a touchscreen device that provides both output and input to a user. In one example, display subsystem 1130 includes a high definition (HD) or ultra-high definition (UHD) display that provides an output to a user. In one example, display subsystem includes or drives a touchscreen display. In one example, display subsystem 1130 generates display information based on data stored in memory or based on operations executed by processor 1110 or both.

I/O controller 1140 represents hardware devices and software components related to interaction with a user. I/O controller 1140 can operate to manage hardware that is part of audio subsystem 1120, or display subsystem 1130, or both. Additionally, I/O controller 1140 illustrates a connection point for additional devices that connect to system 1100 through which a user might interact with the system. For example, devices that can be attached to system 1100 might include microphone devices, speaker or stereo systems, video systems or other display device, keyboard or keypad devices, buttons/switches, or other I/O devices for use with specific applications such as card readers or other devices.

As mentioned above, I/O controller 1140 can interact with audio subsystem 1120 or display subsystem 1130 or both. For example, input through a microphone or other audio device can provide input or commands for one or more applications or functions of system 1100. Additionally, audio output can be provided instead of or in addition to display output. In another example, if display subsystem includes a touchscreen, the display device also acts as an input device, which can be at least partially managed by I/O controller 1140. There can also be additional buttons or switches on system 1100 to provide I/O functions managed by I/O controller 1140.

In one example, I/O controller 1140 manages devices such as accelerometers, cameras, light sensors or other environmental sensors, gyroscopes, global positioning system (GPS), or other hardware that can be included in system 1100, or sensors 1112. The input can be part of direct user interaction, as well as providing environmental input to the system to influence its operations (such as filtering for noise, adjusting displays for brightness detection, applying a flash for a camera, or other features).

In one example, system 1100 includes power management 1150 that manages battery power usage, charging of the battery, and features related to power saving operation. Power management 1150 manages power from power source 1152, which provides power to the components of system 1100. In one example, power source 1152 includes an AC to DC (alternating current to direct current) adapter to plug into a wall outlet. Such AC power can be renewable energy (e.g., solar power, motion based power). In one example, power source 1152 includes only DC power, which can be provided by a DC power source, such as an external AC to DC converter. In one example, power source 1152 includes wireless charging hardware to charge via proximity to a charging field. In one example, power source 1152 can include an internal battery or fuel cell source.

Memory subsystem 1160 includes memory device(s) 1162 for storing information in system 1100. Memory subsystem 1160 can include nonvolatile (state does not change if power to the memory device is interrupted) or volatile (state is indeterminate if power to the memory device is interrupted) memory devices, or a combination. Memory 1160 can store application data, user data, music, photos, documents, or other data, as well as system data (whether long-term or temporary) related to the execution of the applications and functions of system 1100. In one example, memory subsystem 1160 includes memory controller 1164 (which could also be considered part of the control of system 1100, and could potentially be considered part of processor 1110). Memory controller 1164 includes a scheduler to generate and issue commands to control access to memory device 1162.

Connectivity 1170 includes hardware devices (e.g., wireless or wired connectors and communication hardware, or a combination of wired and wireless hardware) and software components (e.g., drivers, protocol stacks) to enable system 1100 to communicate with external devices. The external device could be separate devices, such as other computing devices, wireless access points or base stations, as well as peripherals such as headsets, printers, or other devices. In one example, system 1100 exchanges data with an external device for storage in memory or for display on a display device. The exchanged data can include data to be stored in memory, or data already stored in memory, to read, write, or edit data.

Connectivity 1170 can include multiple different types of connectivity. To generalize, system 1100 is illustrated with cellular connectivity 1172 and wireless connectivity 1174. Cellular connectivity 1172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), 5G, or other cellular service standards. Wireless connectivity 1174 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 1180 include hardware interfaces and connectors, as well as software components (e.g., drivers, protocol stacks) to make peripheral connections. It will be understood that system 1100 could both be a peripheral device (“to” 1182) to other computing devices, as well as have peripheral devices (“from” 1184) connected to it. System 1100 commonly has a “docking” connector to connect to other computing devices for purposes such as managing (e.g., downloading, uploading, changing, synchronizing) content on system 1100. Additionally, a docking connector can allow system 1100 to connect to certain peripherals that allow system 1100 to control content output, for example, to audiovisual or other systems.

In addition to a proprietary docking connector or other proprietary connection hardware, system 1100 can make peripheral connections 1180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), or other type.

In general with respect to the descriptions herein, in one example a device to communicate over an N-bit bus includes: a unidirectional receive interface to couple to a unidirectional signal line to receive signals from a companion device; a unidirectional transmit interface to couple to a unidirectional signal line to transmit signals to the companion device; and (N−1) bidirectional interfaces to couple to (N−1) bidirectional signal lines to transmit signals to and receive signals from the companion device.

In one example, the unidirectional receive interface is to receive metadata from the companion device when transmitting to the companion device with the (N−1) bidirectional interfaces. In one example, the receive interface is to receive metadata to train a master I/O (input/output) setting to prepare to receive signals from the companion device over the (N−1) bidirectional signal lines with the (N−1) bidirectional interfaces. In one example, the receive interface is to receive metadata to train an I/O power, I/O speed, I/O voltage, or I/O phase. In one example, the receive interface is to receive metadata to train a decision feedback equalizer (DFE) circuit of the (N−1) bidirectional interfaces. In one example, all (N−1) bidirectional interfaces are to apply the master I/O setting. In one example, the (N−1) bidirectional interfaces are to apply the master I/O setting initially and adjust the I/O setting for a specific bidirectional interface. In one example, the (N−1) bidirectional interfaces are to apply the master I/O setting with a slave offset. In one example, the N-bit bus comprises a data bus. In one example, N comprises a width of a device data interface. In one example, the companion device comprises a memory controller for a memory device. In one example, the companion device comprises a memory device for a memory controller.

In general with respect to the descriptions herein, in one example a system includes: a memory controller; and a memory device coupled to the memory controller over an N-bit data bus, the memory device including: a unidirectional receive interface to couple to a unidirectional signal line to receive signals from the memory controller; a unidirectional transmit interface to couple to a unidirectional signal line to transmit signals to the memory controller; and (N−1) bidirectional interfaces to couple to (N−1) bidirectional signal lines to transmit signals to and receive signals from the memory controller.

In one example, the unidirectional receive interface is to receive metadata from the memory controller when transmitting to the memory controller with the (N−1) bidirectional interfaces. In one example, the receive interface is to receive metadata to train a master I/O (input/output) setting to prepare to receive signals from the memory controller over the (N−1) bidirectional signal lines with the (N−1) bidirectional interfaces. In one example, the receive interface is to receive metadata to train an I/O power, I/O speed, I/O voltage, I/O phase, or a decision feedback equalizer (DFE) circuit of the (N−1) bidirectional interfaces. In one example, all (N−1) bidirectional interfaces are to apply the master I/O setting. In one example, the (N−1) bidirectional interfaces are to apply the master I/O setting initially and adjust the I/O setting for a specific bidirectional interface. In one example, the (N−1) bidirectional interfaces are to apply the master I/O setting with a slave offset. In one example, the system further includes one or more of: a host processor device coupled to the memory controller; a display communicatively coupled to a host processor; a network interface communicatively coupled to a host processor; or a battery to power the system.

In general with respect to the descriptions herein, in one example a device to communicate over a bus includes: a unidirectional receive interface to couple to a first signal line only to receive signals from a companion device; a unidirectional transmit interface to couple to a second signal line only to transmit signals to the companion device; and (N−1) bidirectional interfaces to couple to (N−1) signal lines separate from the first and second signal lines, to transmit signals to and receive signals from the companion device.

In one example, the unidirectional receive interface is to receive metadata from the companion device when transmitting to the companion device with the (N−1) bidirectional interfaces. In one example, the receive interface is to receive metadata to train a master I/O (input/output) setting to prepare to receive signals from the companion device with the (N−1) bidirectional interfaces. In one example, the receive interface is to receive metadata to train an I/O power, I/O speed, I/O voltage, or I/O phase. In one example, the receive interface is to receive metadata to train a decision feedback equalizer (DFE) circuit of the (N−1) bidirectional interfaces. In one example, all (N−1) bidirectional interfaces are to apply the master I/O setting. In one example, the (N−1) bidirectional interfaces are to apply the master I/O setting initially and adjust the I/O setting for a specific bidirectional interface. In one example, the (N−1) bidirectional interfaces are to apply the master I/O setting with a slave offset. In one example, the bus comprises N+1 bits to implement an N-bit data bus in each direction between the companion devices. In one example, N comprises a width of a device data interface. In one example, the companion device comprises a memory controller for a memory device. In one example, the companion device comprises a memory device for a memory controller.

In general with respect to the descriptions herein, in one example a system includes: a memory controller; and a memory device coupled to the memory controller over a data bus, the memory device including: a unidirectional receive interface to couple to a first signal line only to receive signals from the memory controller; a unidirectional transmit interface to couple to a second signal line only to transmit signals to the memory controller; and (N−1) bidirectional interfaces to couple to (N−1) signal lines separate from the first and second signal lines, to transmit signals to and receive signals from the memory controller.

In one example, the unidirectional receive interface is to receive metadata from the memory controller when transmitting to the memory controller with the (N−1) bidirectional interfaces. In one example, the receive interface is to receive metadata to train a master I/O (input/output) setting to prepare to receive signals from the memory controller with the (N−1) bidirectional interfaces. In one example, the receive interface is to receive metadata to train an I/O power, I/O speed, I/O voltage, I/O phase, or a decision feedback equalizer (DFE) circuit of the (N−1) bidirectional interfaces. In one example, all (N−1) bidirectional interfaces are to apply the master I/O setting. In one example, the (N−1) bidirectional interfaces are to apply the master I/O setting initially and adjust the I/O setting for a specific bidirectional interface. In one example, the (N−1) bidirectional interfaces are to apply the master I/O setting with a slave offset. In one example, the system further includes: a host processor device coupled to the memory controller; a display communicatively coupled to a host processor; a network interface communicatively coupled to a host processor; or a battery to power the system.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A device to communicate over a bus, comprising:
a unidirectional receive interface to couple to a first signal line only to receive signals from a companion device;
a unidirectional transmit interface to couple to a second signal line only to transmit signals to the companion device; and
(N−1) bidirectional interfaces to couple to (N−1) signal lines separate from the first and second signal lines, to transmit signals to and receive signals from the companion device.

2. The device of claim 1, wherein the unidirectional receive interface is to receive metadata from the companion device when transmitting to the companion device with the (N−1) bidirectional interfaces.

3. The device of claim 2, wherein the receive interface is to receive metadata to train a master I/O (input/output) setting to prepare to receive signals from the companion device with the (N−1) bidirectional interfaces.

4. The device of claim 3, wherein the receive interface is to receive metadata to train an I/O power, I/O speed, I/O voltage, or I/O phase.

5. The device of claim 3, wherein the receive interface is to receive metadata to train a decision feedback equalizer (DFE) circuit of the (N−1) bidirectional interfaces.

6. The device of claim 3, wherein all (N−1) bidirectional interfaces are to apply the master I/O setting.

7. The device of claim 3, wherein the (N−1) bidirectional interfaces are to apply the master I/O setting initially and adjust the I/O setting for a specific bidirectional interface.

8. The device of claim 3, wherein the (N−1) bidirectional interfaces are to apply the master I/O setting with a slave offset.

9. The device of claim 1, wherein the bus comprises N+1 bits to implement an N-bit data bus in each direction between the companion devices.

10. The device of claim 1, wherein N comprises a width of a device data interface.

11. The device of claim 1, wherein the companion device comprises a memory controller for a memory device.

12. The device of claim 1, wherein the companion device comprises a memory device for a memory controller.

13. A system, comprising:
a memory controller; and
a memory device coupled to the memory controller over a data bus, the memory device including:
a unidirectional receive interface to couple to a first signal line only to receive signals from the memory controller;
a unidirectional transmit interface to couple to a second signal line only to transmit signals to the memory controller; and
(N−1) bidirectional interfaces to couple to (N−1) signal lines separate from the first and second signal lines, to transmit signals to and receive signals from the memory controller.

14. The system of claim 13, wherein the unidirectional receive interface is to receive metadata from the memory controller when transmitting to the memory controller with the (N−1) bidirectional interfaces.

15. The system of claim 14, wherein the receive interface is to receive metadata to train a master I/O (input/output) setting to prepare to receive signals from the memory controller with the (N−1) bidirectional interfaces.

16. The system of claim 15, wherein the receive interface is to receive metadata to train an I/O power, I/O speed, I/O voltage, I/O phase, or a decision feedback equalizer (DFE) circuit of the (N−1) bidirectional interfaces.

17. The system of claim 15, wherein all (N−1) bidirectional interfaces are to apply the master I/O setting.

18. The system of claim 15, wherein the (N−1) bidirectional interfaces are to apply the master I/O setting initially and adjust the I/O setting for a specific bidirectional interface.

19. The system of claim 15, wherein the (N−1) bidirectional interfaces are to apply the master I/O setting with a slave offset.

20. The system of claim 13, further comprising one or more of:
a host processor device coupled to the memory controller;
a display communicatively coupled to a host processor;
a network interface communicatively coupled to a host processor; or
a battery to power the system.
